(19) United States
(12) Patent Application Publication
(10) Pub. No.: US 2024/0077295 A1
(43) Pub. Date: Mar. 7, 2024

(54) COMBINED MEASURING AND STUD-FINDING DEVICE

(71) Applicant: Victor Telega, Bismarck, ND (US)

(72) Inventor: Victor Telega, Bismarck, ND (US)

(21) Appl. No.: 17/939,340

(22) Filed: Sep. 7, 2022

(51) Int. Cl. G01B 3/1092; G01V 3/08

(52) U.S. Cl. CPC G01B 3/1092; G01V 3/088

(57) ABSTRACT

Aspects of the present disclosure relate to a device that can measure distances and that can detect subsurface objects, such as studs. In example embodiments, the device can include a housing that includes aspects of a tape measure and aspects of a stud finder. The tape measure may comprise a measuring tape, reel, and spring. The stud finder may comprise one or more circuit boards, signaling mechanisms, one or more sensors, and a circuit configured to detect a sub surface object.

### BACKGROUND

Before driving an object into a wall, a person may need to detect whether there is something behind the wall. At the same time, the person may need to measure distances. For example, a person seeking to mount an object on a wall may need to determine a position of one or more studs, and the person may need to measure a distance between studs, or a distance from the mounting position to another point, such as the floor, an adjacent wall, or ceiling.

### SUMMARY

In general, the subject matter of the present disclosure relates to a device that can measure distances and detect subsurface objects. In particular, aspects of the present disclosure include a device combining a stud finder and a tape measure.

In an example aspect, a measuring and object-detecting device is disclosed. The device includes a housing defining a slot; a sensor; a circuit coupled to the sensor, the circuit being configured to receive an input from the sensor and to determine, based on the input, whether the sensor is positioned adjacent to an object; and a measuring tape wound around a reel; wherein the housing comprises the sensor, the circuit, and the reel; and wherein a portion of the measuring tape extends through the slot.

In a second aspect, a method of manufacturing a combined tape measure and stud finder is disclosed. The method comprises providing a housing, wherein a width of the housing is substantially similar to a height of the housing; disposing a sensor in the housing, the sensor being in contact with a flat backside of the housing; disposing a circuit in a top portion of the housing, the circuit being coupled to the sensor; mounting a reel in a bottom portion of the housing; and winding a measurement tape around the reel, wherein a portion of the measurement tape extends through a slot of the housing; wherein the circuit is configured to receive an input from the sensor and to determine, based on the input, whether the sensor is positioned adjacent to a stud.

In a third aspect, a combined stud finder and tape measure device is disclosed. The device comprises a housing defining a slot, a width of the housing being substantially similar to a height of the housing; a sensor; a circuit coupled to the sensor, the circuit being configured to receive an input from the sensor and to determine, based on the input, whether the sensor is positioned adjacent to a stud; and a measuring tape wound around a reel; wherein the housing comprises the sensor, the circuit disposed in a top portion of the housing, and the reel disposed in a bottom portion of the housing; wherein a portion of the measuring tape extends through the slot; wherein the housing has a flat back surface that defines a plane; and wherein the portion of the measuring tape extending through the slot is substantially perpendicular to the plane.

### BRIEF DESCRIPTION OF THE DRAWINGS

FIG. 1 illustrates an example application of a device.

FIG. 2A illustrates another embodiment of a front view of the device from FIG. 1.

FIG. 2B illustrates yet another embodiment of a front view of the device from FIG. 1.

FIG. 3 illustrates a side view of the device from FIG. 1.

FIG. 4 illustrates a top view of the device from FIG. 1.

FIG. 5 illustrates a bottom view of the device from FIG. 1.

FIG. 6A illustrates a front sectional view of an interior of the device from FIG. 1.

FIG. 6B illustrates a side sectional view of the interior of the device from FIG. 1.

FIG. 7 is a flowchart of an example method for manufacturing the device from FIG. 1.

### DETAILED DESCRIPTION

As briefly described above, aspects of the present disclosure include a device that combines a stud finder and a tape measure. In example aspects, the device can be shaped like a tape measure with a stud finder apparatus in a top portion of the device and a tape measure apparatus in a bottom portion of the device. The stud finder apparatus can, in some embodiments, detect a change in density or capacitance behind a surface to locate a stud. The tape measurement apparatus can, in some embodiments, include a variety of components, including, for example, a reel, a measuring tape wrapped around the reel, a spring, and a tape locking arm.

In example aspects, the disclosed device can include various features for improving the accuracy and useability of the device. In some embodiments, the device can include a plurality of lights around the device, thereby guiding a user when searching for studs or taking measurements. In some embodiments, the device can include a plurality of buttons to actuate various components, including lights, the tape measure, and the stud finder. Furthermore, in some embodiments, the measuring tape can be positioned perpendicular to a backside of the device where stud-finding sensors are placed, thereby improving the useability of the device in certain positions and, in some examples, improving the readability of markings on the measurement tape.

Certain embodiments of the present disclosure have certain features that make them particularly advantageous over existing tools. For example, embodiments of the present disclosure enable a person to find a stud and measure distances using only one device, thereby improving efficiency and minimizing the required number of tools to perform a job. Yet still, by including a plurality of lights at various positions on the device, such as on a front surface, side surface, and top surface of the device, aspects of the present disclosure can improve the accuracy of both finding studs and measuring distances.

Furthermore, by positioning the measurement tape to be perpendicular to a back surface of the device, aspects of the present disclosure allow a person to better read measurements from certain angles, such as from an angle above the device, thereby improving accuracy and the ease by which the disclosed device can be used. Furthermore, by positioning the measurement tape at a perpendicular angle to a back surface, the device can simultaneously hook to a projection from a wall, measure a distance from the projection, and search for a stud. Yet still, by situating a tape measure and a stud finder within a housing that is shaped like a tape measure, having a substantially similar width, height, the device can, in some situations, be easier to handle, fit in small spaces, easily clip to a belt, and be stored in spaces designed for tape measures. As will be apparent, these are only some of the advantages offered by aspects of the present disclosure.

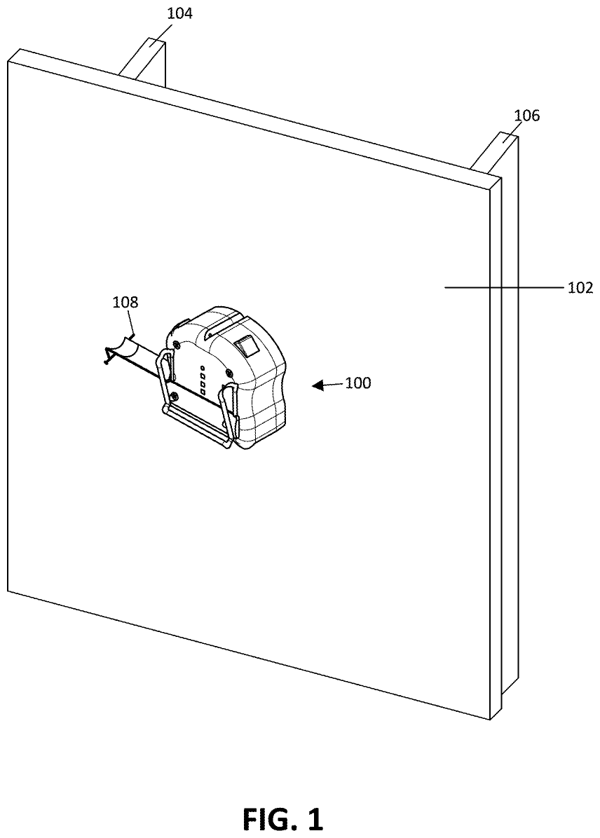

FIG. 1 illustrates an example application of a device 100 that combines a stud finder and a tape measure. FIG. 1 illustrates the device 100, a wall section 102, studs 104-106, and a projection 108, which can be, for example, a nail or another object attached to the wall section 102. As illustrated in the example of FIG. 1, the device 100 and the projection 108 can be disposed on an outer side of the wall section 102, and the studs 104-106 can be disposed on an inner side of the wall section 102.

As is further described below, the device 100 can include one or more sensors on a backside that, in the example of FIG. 1, is flat against the wall section 102. In some embodiments, the device 100 can, using the one or more sensors, detect the subsurface studs 104-106. In some examples, a user of the device 100—having detected the stud 104 using the device 100—can insert the projection 108 through the wall section 102 into the stud 104. As shown, the user can then attach a hook of a measurement tape of the device 100 to the projection 108. A user can then move the device 100 along the wall section 102 in search of another subsurface object, such as the stud 106. Thus, the device 100 allows a user to both search for a stud and measure a distance at the same time, thereby increasing the efficiency of performing both tasks. Furthermore, in some examples, the hook of the tape measure can be attached to an edge of the wall or to another point, instead of the projection 108. Furthermore, the tape measure and the stud finder of the device 100 may also be used separately. As will be understood, the use of the device 100 in the example of FIG. 1 is for illustrative purposes, and the device 100 is not limited to the example use of FIG. 1.

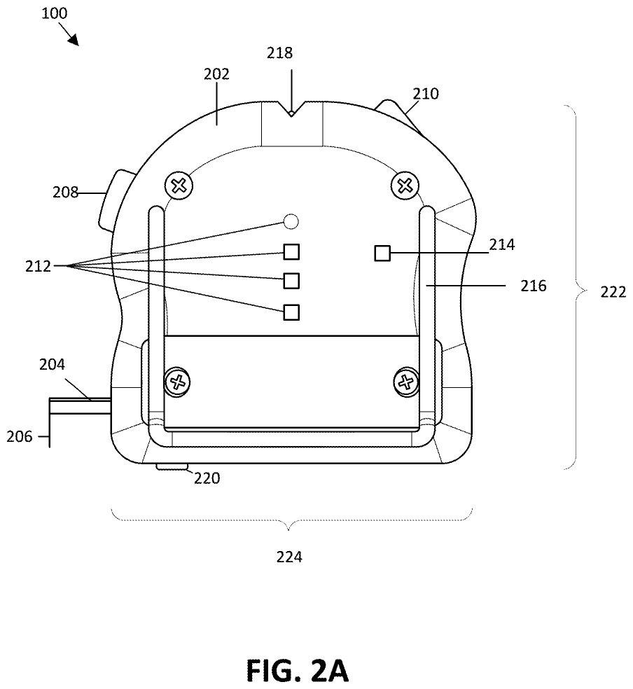

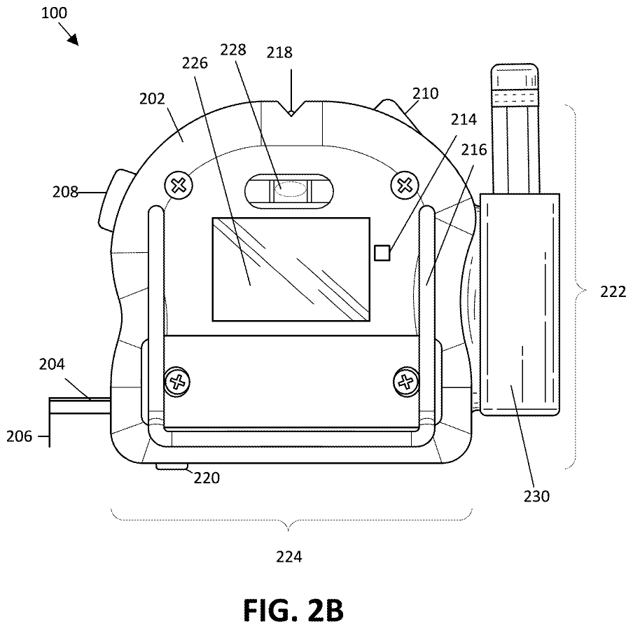

FIG. 2A and FIG. 2B illustrate different embodiments of a front view of the device from FIG. 1. FIG. 2A illustrates an embodiment of a front view of the device 100. Additionally, FIG. 2A illustrates a front view of a housing 202 of the device 100, a measuring tape 204, a hook 206, a tape release button 208, a stud finder button 210, a plurality of signaling lights 212, an AC scan indicator light 214, a clip 216, a top light 218, and a measurement light switch 220.

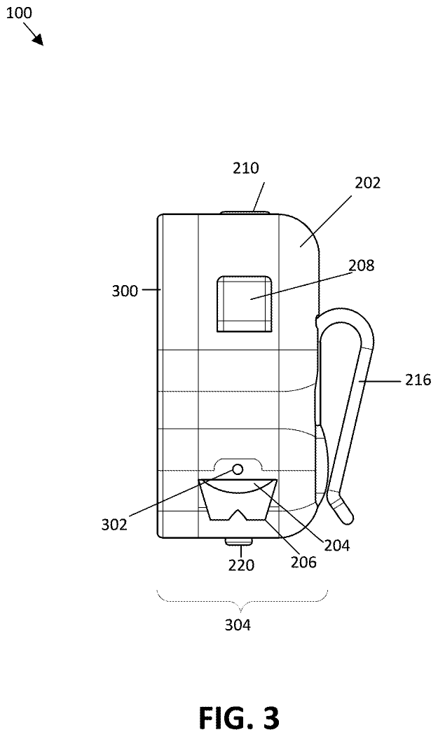

In some embodiments, the housing 202 of the device 100 can be made of plastic, metal, or a combination of materials. As shown, the housing 202 can have sides that are indented and grooved, thereby improving, in some examples, the ease by which the device 100 can be gripped and handled by a user. Furthermore, the housing 202 can have dimensions, including a height 222, a width 224 and a depth 304 (as illustrated in FIG. 3). In some embodiments, the housing can have a substantially square shape. For example, in some embodiments, the height 222 of the housing 202 can be substantially similar to the width 224 of the housing 202. Typically, the height 222 and width 224 of the housing 202 can be approximately 3.75 inches. However, the height 222 of the housing 202 can, depending on the embodiment, range from 2 inches to 5 inches, the width 224 of the housing 202 can, depending on the embodiment, range from 2 inches to 5 inches and the depth 304 of the housing (as illustrated in relation to FIG. 3) can, depending on the embodiment, be range between 1.5 and 3.5 inches. In some examples, the device 100, by having a compact and square-like housing 202, can—unlike, for example, devices with a more elongated shape—be easier to use in small spaces, easier to clip to a belt, and easier to use as a conventional tape measure. Similarly, the clip 216 can be used to attach the device 100 to, for example, a belt or another object for convenient use and storage.

The device 100 includes a stud finder and a tape measure. In some embodiments, the stud finder components can primarily be disposed in the top portion of the device 100, and the tape measurement components can primarily be disposed in the bottom portion of the device 100. The measuring tape 204 and the hook 206 can be part of the tape measure. As shown, the hook 206 and a portion of the measuring tape 204 can extend out from the housing 202. The measuring tape 204 can include markings, for example in inches or centimeters, that can be used to measure distances. The hook 206 can be attached to an end of the measuring tape 204. As is further described below, the device 100 can include a measurement light on a left side of the housing that can be used to provide light on, for example, the markings of the measuring tape 204. In some embodiments, the measurement light switch 220 can turn the measurement light on and off.

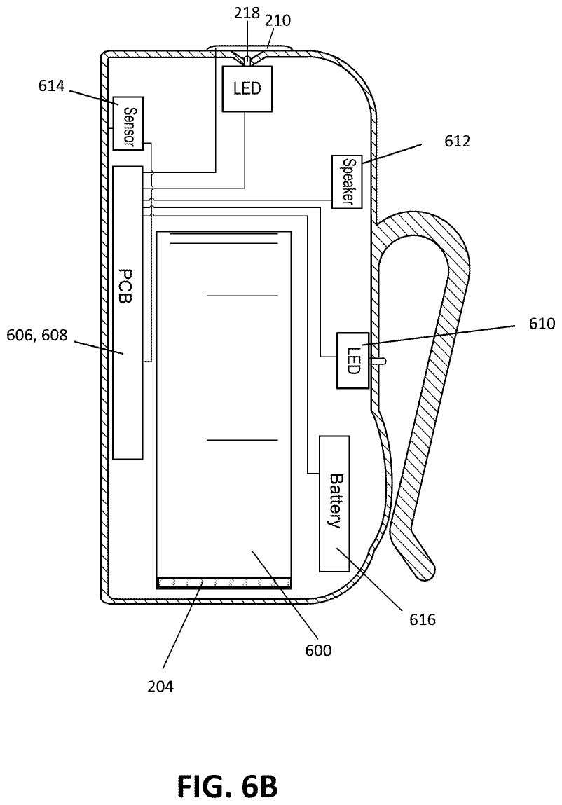

As is further described below in connection with FIGS. 6A and 6B, the measuring tape 204 can be coiled around a reel inside the housing 202 of the device and, as shown in the example of FIGS. 2A and 2B, a portion of the measuring tape 204 can extend through a slot of the housing 202. In response to a pulling force, the measuring tape 204 can be pulled further through the slot of the housing 202, thereby unwinding the measuring tape 204 from the reel inside the housing 202. As is further described below in connection with FIGS. 6A and 6B, the reel can be coupled to a spring that causes the reel to rotate, thereby winding the measuring tape 204 around the reel. In example embodiments, a force of the spring can, as is further described below, be countered by a tape locking arm. In some embodiments, the tape release button 208 can be coupled to the tape locking arm and, when pressed, the tape release button 208 can cause the tape locking arm to disengage, thereby allowing the spring attached to the reel to wind the measuring tape 204 around the reel.

Continuing with the example of FIGS. 2A and 2B, the device 100 includes a stud finder button 210. In some embodiments, a pressing force on the stud finder button 210 can actuate the stud finder. As is further described below in connection with FIGS. 6A and 6B, the stud finder, when activated, can activate a signal in response to a sensor (e.g., on a backside of the device 100) being adjacent to a subsurface object, such as a stud. The activation signal can, in some examples, be the plurality of lights 212. For example, as the device 100 moves closer to a stud, the number of activated lights of the plurality of lights 212 can increase or the plurality of lights 212 can change color. In some embodiments, the top light 218 can also be a signal that emits light in response to the device 100 detecting a subsurface object. In some embodiments, the top light 218 can be an LED. By having the plurality of lights 212 on a front surface and the top light 218 on a top surface, a user of the device 100 can be positioned at various angles relative to the device 100 and still be able to use the device 100 to detect studs.

Furthermore, in some embodiments, the device 100 can include a speaker that emits a sound in response to the stud finder detecting a stud. Additionally, in some embodiments, the device 100 can detect subsurface electrical wiring. For example, a force on the stud finder button 210 can, in some examples, cause the stud finder to switch to a mode for detecting wiring. Thereafter, in response to the device 100 being adjacent to subsurface electrical wiring, the AC scan indicator light 214 can emit light.

FIG. 2B illustrates another embodiment of a front view of the device 100. In some embodiments, the device 100 may be configured to the front view of the device 100 from FIG. 2A, but include one or more features that are different than the embodiment of device 100 described in FIG. 2A.

For example, in FIG. 2A, the detection of a subsurface object is conveyed to the user using a plurality of lights 212. In another embodiment of the device 100, as illustrated in FIG. 2B, the detection of a subsurface object may be conveyed using a digital display 226 instead of or in addition to the plurality of lights 212.

For example, the digital display 226 may be included on the front surface of the device 100. The digital display 226 may include one or more lines or arrows that may be blinking to indicate when the device 100 is approaching a subsurface object, such as a stud. When the device 100 is positioned directly adjacent to the subsurface object, the digital display 226 may have a solid, unblinking arrow in the center of the digital display 226 to indicate that the subsurface object has been detected. The digital display 226 may also be illuminated by one or more colors. For example, the digital display 226 may be illuminated in red when the subsurface object is not close to the device 100, illuminated in yellow when the subsurface object is approaching and close to the device 100, but the object is not directly overhead the subsurface object and illuminated in green when the device 100 is positioned directly overhead the subsurface object.

Device 100, in some embodiments, may include one or more additional features such as the level finder 228 and the writing utensil holder 230. Although FIG. 2B illustrates the level finder 228 and the writing utensil holder 230 on device 100 that also includes the digital display 226, the level finder 228 and/or the writing utensil holder 230 may be also be included within the embodiment of the device 100 illustrated in FIG. 2A that includes a plurality of lights 212 to convey the detection of a subsurface object. In other examples, the device 100 may include both, only one or none of: the level finder 228 and the writing utensil holder 230.

The level finder 228 may include an instrument that is configured to indicate whether a surface is horizontal. Although level finder 228 in FIG. 2B is illustrated as a spirit level or bubble level, the level finder 228 may include other types of level finders as well. For example, the level finder 228 may be positioned on the front surface of the device 100 and may include a glass vial with a constant inner diameter that is incompletely filled with a liquid, causing the formation of a bubble within the vial. The level finder 228 is configured such that the bubble naturally rests in the center of the vial when the level finder is positioned completely horizontal. The liquid may include a colored spirit or alcohol with low viscosity and surface tension, which allows the bubble to travel the tube quickly and settle accurately with minimal interference from the glass surface.

The writing utensil holder 230 may include a cylindrical container that enclosed in one end and includes an opening on the other end that allows for a writing utensil, such as a pencil or pen to be inserted into the cylindrical container. The writing utensil holder 230 may be attached to a side surface or a front surface of the device 100. The writing utensil holder 230 may allow the user to store a writing utensil on the device 100, such that the user may be able to access the writing utensil to take notes or make markings on surfaces with the writing utensil when using the device 100.

FIG. 3 illustrates a side view of the device 100. The side view of the device 100 shown in the example of FIG. 3 illustrates the housing 202, the measuring tape 204, the hook 206, the tape release button 208, the stud finder button 210, the clip 216, and the measurement light switch 220. Furthermore, the example of FIG. 3 illustrates a backside 300 of the housing 202 and a measurement light 302.

In some embodiments, the backside 300 of the housing 202 can be flat. As is further described below in connection with FIGS. 6A and 6B, the device 100 can include one or more sensors that are attached to the backside 300. As shown in the example of FIG. 1, the backside 300 can be flush against a wall when using the device 100 to detect subsurface objects. As shown, the flat backside 300 can define a plane that, when the device 100 is flush against a wall, is parallel with the wall. Furthermore, in some examples, the measuring tape 204, or a plane defined by the measuring tape 204, can be perpendicular to the plane defined by the backside 300, thereby allowing, in some examples, the hook 206 to securely fasten to a projection from a wall. The measurement light 302 can be an LED that, when turned on, provides light on the markings of the measuring tape 204 and on, for example, objects that are near the device 100.

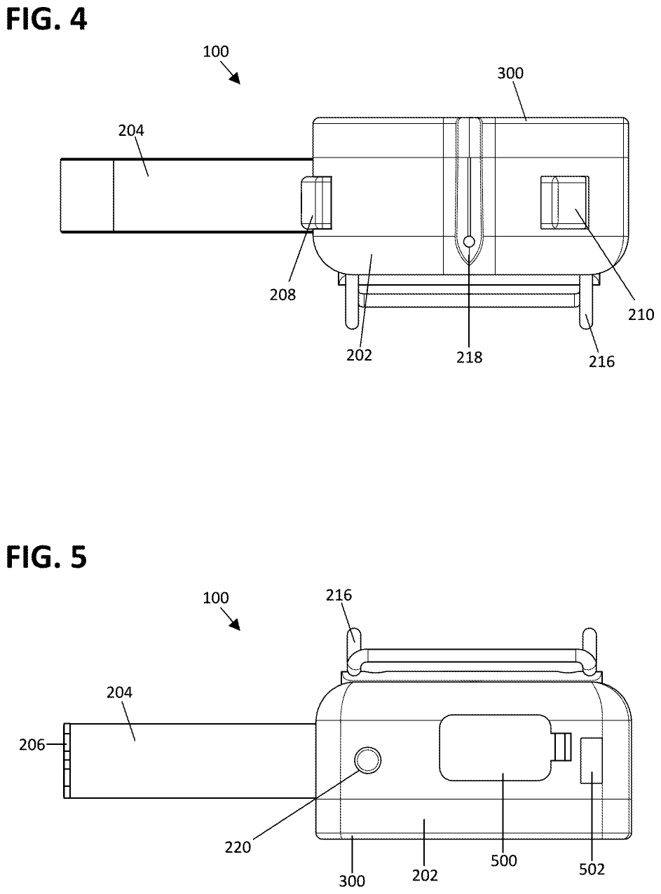

FIG. 4 illustrates a top view of the device 100. FIG. 4 illustrates a top view of the housing 202, the measuring tape 204, the tape release button 208, the stud finder button 210, the clip 216, the top light 218, and the backside 300 of the housing 202. As shown in the top view, a user of the device 100 positioned above the device 100 can, in some embodiments, easily detect, based on the top light 218, whether the device 100 has detected a stud.

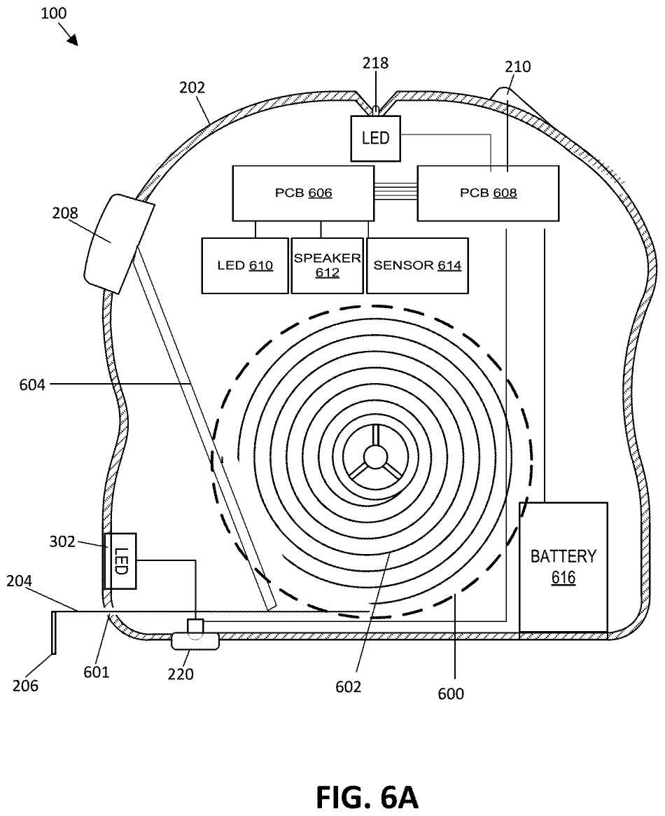

FIG. 5 illustrates a bottom view of the device 100. FIG. 5 illustrates a bottom view of the housing 202, the measuring tape 204, the hook 206, the clip 216, the measurement light switch 220, and the backside 300 of the housing 202. Furthermore, as shown in FIG. 5, the device 100 can, in some embodiments, include a battery access panel 500 and a slot 502, which can, in some embodiments, be a USB port. The battery access panel 500 can be, for example, a movable cover that, when closed, can be flush with the housing 202. When open, the battery access panel 500 can, for example, provide access to a battery within the housing 202. As is further described below, the device 100 can include a battery to, for example, power one or more components of the stud finder or one or more lights. In some examples, a user can charge the battery via the USB port 502.

FIG. 6A and FIG. 6B illustrate front and side sectional views of an interior of the device from FIG. 1. FIG. 6A illustrates a front sectional view of the device 100. In the example of FIG. 6A, components of the device 100 disposed within the housing 202 are shown. As shown, the device 100 comprises components for a tape measure that are primarily disposed in a bottom portion of the housing 202, and the device 100 comprises components for a stud finder that are primarily disposed in a top portion of the housing 202.

In the example of FIGS. 6A and 6B, the device 100 illustrates components that make up a tape measure. For example, the device 100 includes the measuring tape 204, the hook 206, a reel 600, a spring 602, and a tape locking arm 604. As shown, a portion of the measuring tape 204 can extend out from the housing 202 via the slot 601. Within the housing 202, a reel 600 can be rotatably mounted in the housing 202, and the measuring tape 204 can be wound around the reel 600. In some embodiments, a spring 602 can be disposed in the reel 600 and wound in a coil. An end of the spring 602 can be attached to a rotating shaft. In some embodiments, an elastic force provided by the spring 602 can wind the measuring tape 204 around the reel 600.

However, as shown in the example of FIG. 6A, a tape locking arm 604 can, in an engaged position, prevent the elastic force provided by the spring 602 from retracting the measuring tape 204. Furthermore, in some embodiments, the tape locking arm 604 can, in the engaged position, allow the measuring tape 204 to be pulled through the slot 601, thereby unwinding the measuring tape 204 and extending the portion of the measuring tape 204 that is outside of the housing 202. In response to a force on the tape release button 208, the tape locking arm 604 can be moved to an unengaged position. In an unengaged position, the tape locking arm 604 can, in some embodiments, allow the elastic force provided by the spring 602 to wind the measuring tape 204 around the reel 600, thereby retracting a portion of the measuring tape 204 and allowing the measuring tape 204 to move in a direction toward the housing 202.

Continuing with the example of FIGS. 6A and 6B, the device 100 can include electrical components. For example, the device 100 can include a top light 218, measurement light 302, printed circuit boards 606-608, LED 610, a speaker 612, a sensor 614, and a battery 616. In some embodiments, each of the stud finder button 210, LEDs 218, 302, and 610, the speaker 612, the sensor 614, and the battery 616 can be coupled to the printed circuit boards 606-608. In some embodiments, the printed circuit boards 606-608 can, as shown, be coupled to one another via ribbon wire.

In some embodiments, stud sensing circuitry is provided in the circuit boards 606-608. In some examples, the stud sensing circuitry is powered on in response to a pressing force on the stud finder button 210. When activated, the stud sensing circuitry can be configured to sense a capacitance using the sensor 614. For example, the sensor 614 can, in some embodiments, be in contact with the back surface 300 of the housing 202. In some embodiments, when the device 100 is positioned adjacent to a wall, the stud sensing circuitry can be configured to sense the capacitance in the wall.

Furthermore, the stud sensing circuitry can be configured to compare a sensed capacitance to a baseline capacitance, which can be a capacitance when there is no stud. As the device 100 moves along a wall and approaches a stud, the stud sensing circuitry can be configured to detect a change in capacitance and emit a signal in response to a sensed capacitance being sufficiently different from the baseline capacitance.

To emit a signal, the stud sensing circuitry can, in some examples, cause one or more of the top light 218 or the LED 610 to emit light. In some examples, the LED 610 can be a plurality of lights, such as the lights 212 of FIG. 2A. In some embodiments, the stud sensing circuitry can be configured to emit a sound via the speaker 612 in response to detecting a stud. In some embodiments, the stud sensing circuitry can be configured to sense a stud using different techniques, such as by detecting a magnetic field of a nail, screw, or other object in a subsurface stud.

Additionally, in some embodiments, circuitry disposed in the circuit boards 606-608 can be configured to detect subsurface electrical wiring. As the device 100 moves along a wall, the circuitry can be configured to cause the AC indicator light 214 to emit light in response to detecting, using the sensor 614, subsurface electrical wiring. In the example shown, electrical components of the device 100 can be powered by the battery 616.

In addition to the components shown in the example of FIG. 6A, the device 100 can include more components. For example, depending on the embodiment, the device 100 can include more components connected to the circuit boards 606-608, and the device 100 can include more components that make up the tape measure.

FIG. 6B illustrates a side sectional view of the device 100. The side section view of the device 100 illustrates one example of the placement of the top light 218, the reel 600, circuit boards 606-608, the LED 610, the speaker 612, the sensor 614, and the battery 616 within the housing 202. Other examples of for positioning the top light 218, the reel 600, circuit boards 606-608, the LED 610, the speaker 612, the sensor 614, and the battery 616 within the housing 202 are also possible.

For example, the reel 600 may be centrally located within the housing 202 with the circuit boards 606-608 and sensor 614 located on one side of the reel 600 and the LED 610, the speaker 612 and the battery 616 located on the other side of the reel 600. For example, the circuit boards 606-608 and sensor 614 may be located between the reel 600 and a side of the housing 202 of the device 100 that faces or is adjacent to the surface when the device 100 is used to detect subsurface objects. The LED 610, the speaker 612 and the battery 616 may be located between the reel 600 and a side of the housing 202 of the device 100 that faces the user when the device 100 is used to detect subsurface objects.

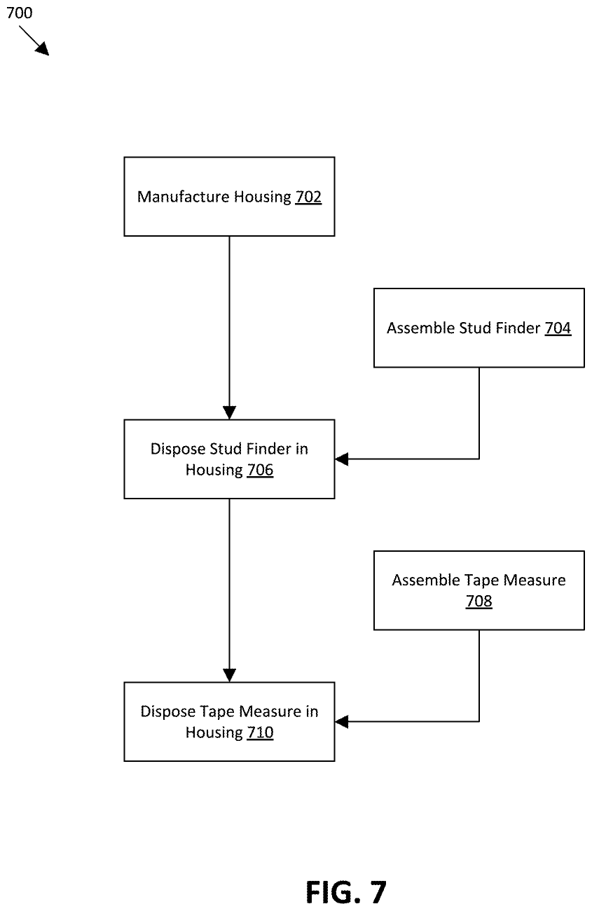

FIG. 7 is a flowchart of an example method 700 for manufacturing a device. In the example shown, a housing can be manufactured (step 702). In some examples, the housing can be manufactured from plastic, metal, or a combination of materials. The housing can, in some examples, have a height that is substantially similar to its width, and it can have a flat backside. Furthermore, in some embodiments, the housing can define a slot for a portion of a tape measure and openings for other components, such as openings for wiring to buttons and batteries.

In the example shown, a stud finder can be assembled (step 704). The stud finder can, in some examples, include electrical components, such as those shown in the example of FIGS. 6A and 6B. In the example shown, the stud finder can be disposed in the housing (step 706). For example, circuit boards of the stud finder can be disposed in a top portion of the housing, and a sensor of the stud finder can be attached to the backside of the housing. Furthermore, one or more lights connected to the stud finding circuitry can be disposed in the housing. An example positioning of some components of the stud finder is further described above in connection with FIGS. 6A and 6B.

In the example shown, a tape measure can be assembled (step 708). In some embodiments, the tape measure can include a measuring tape, a reel, a spring, and other components. Assembling the tape measure can include providing measurement markings on the measuring tape, attaching a hook to an end of the measuring tape, disposing the spring within the reel, and wrapping the measuring tape around the reel. In the example shown, the tape measure can be disposed in the housing (step 710). For example, components of the tape measure can, in some embodiments, be primarily disposed in a lower portion of the tape measure. Disposing the tape measure in the housing can, in some embodiments, include mounting the reel to a position in the housing and positioning a portion of the measurement tape to extend out from the housing via a slot of the housing.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the devices and components disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. The scope of the technology is defined by the following claims and any equivalents therein.

1. A measuring and object-detecting device comprising:
a housing defining a slot, wherein the housing comprises:
a sensor;
a circuit coupled to the sensor, the circuit being configured to receive an input from the sensor and to determine, based on the input, whether the sensor is positioned adjacent to an object; and
a measuring tape wound around a reel; and
wherein a portion of the measuring tape extends through the slot.

2. The measuring and object-detecting device of claim 1, wherein a height of the housing ranges between 3.5 inches and 4 inches and a width of the housing ranges between 3.5 inches and 4 inches.

3. The measuring and object-detecting device of claim 1,
wherein the housing has a flat back surface that defines a plane; and
wherein the portion of the tape extending through the slot is substantially perpendicular to the plane.

4. The measuring and object-detecting device of claim 1, wherein the housing comprises a top portion and a bottom portion, the circuit being disposed in the top portion and the reel being disposed in the bottom portion.

5. The measuring and object-detecting device of claim 1, wherein the object is a stud.

6. The measuring and object-detecting device of claim 1, further comprising:
a signaling mechanism coupled to the circuit, wherein the signaling mechanism provides a signal in response to the circuit determining that the sensor is positioned adjacent to the object.

7. The measuring and object-detecting device of claim 6, wherein the signaling mechanism is a light.

8. The measuring and object-detecting device of claim 6, wherein the signaling mechanism includes a top light and a plurality of front lights, the top light being disposed on a top surface of the housing and the plurality of front lights being disposed on a front surface of the housing.

9. The measuring and object-detecting device of claim 1, wherein the input is associated with a change in a capacitance level detected by the sensor.

10. The measuring and object-detecting device of claim 1, further comprising a tape locking arm, wherein the tape locking arm, in an engaged position, prevents the measuring tape from moving in a direction toward the housing.

11. The measuring and object-detecting device of claim 10,
further comprising a release button disposed on a surface of the housing and a spring mechanism attached to the reel;
wherein, in response to a force on the release button, the tape locking arm moves to an unengaged position, wherein the tape locking arm, in the unengaged position, does not prevent the measuring tape from moving in the direction toward the housing; and
wherein, in response to the force on the release button, the spring mechanism causes at least some of the portion of tape extending through the slot to retract and wrap around the reel.

12. The measuring and object-detecting device of claim 1, further comprising a rechargeable power supply coupled to the circuitry, wherein the housing defines a second slot for charging the rechargeable power supply.

13. The measuring and object-detecting device of claim 1, further comprising an object finder activation button disposed on a surface of the housing, wherein the circuit receives the input from the sensor subsequent to a pressing force on the object finder activation button.

14. The measuring and object-detecting device of claim 1, further comprising:
a measurement light disposed on a surface of the housing above the slot;
a measurement light switch;
wherein the measurement light is turned on in response to the measurement light switch being in an on position; and
wherein the measurement light provides light on measurement markings of the measuring tape.

15. The measuring and object-detecting device of claim 1, further comprising a clip retainer attached to a front surface of the housing.

16. The measuring and object-detecting device of claim 1, wherein a first side and a second side of the housing are indented and grooved.

17. A method of manufacturing a combined tape measure and stud finder, the method comprising:
providing a housing, wherein a width of the housing is substantially similar to a height of the housing;
disposing a sensor in the housing, the sensor being in contact with a flat backside of the housing;
disposing a circuit in a top portion of the housing, the circuit being coupled to the sensor;
mounting a reel in a bottom portion of the housing; and
winding a measurement tape around the reel, wherein a portion of the measurement tape extends through a slot of the housing;
wherein the circuit is configured to receive an input from the sensor and to determine, based on the input, whether the sensor is positioned adjacent to a stud.

18. The method of claim 17,
wherein the flat backside of the housing defines a plane; and
wherein the portion of the measurement tape extending through the slot is substantially perpendicular to the plane.

19. The method of claim 17,
further comprising disposing a light source on a front side of the housing;
wherein the light source is coupled to the circuit; and
wherein the light source emits light in response to the circuit determining that the sensor is positioned adjacent to the stud.

20. A combined stud finder and tape measure device comprising:
a housing defining a slot,
a sensor;
a circuit coupled to the sensor, the circuit being configured to receive an input from the sensor and to determine, based on the input, whether the sensor is positioned adjacent to a stud; and
a measuring tape wound around a reel;
wherein the housing comprises the sensor, the circuit disposed in a top portion of the housing, and the reel disposed in a bottom portion of the housing;
wherein a portion of the measuring tape extends through the slot;
wherein the housing has a flat back surface that defines a plane; and
wherein the portion of the measuring tape extending through the slot is substantially perpendicular to the plane.
